(19) United States
(12) Patent Application Publication
(10) Pub. No.: US 2018/0061540 A1
(43) Pub. Date: Mar. 1, 2018

(54) METHOD FOR PRODUCING A SINTERED R-IRON-BORON MAGNET

(71) Applicant: Yantai Zhenghai Magnetic Material Co., Ltd., Yantai (CN)

(72) Inventors: Qingkai WANG, Yantai (CN); Dongdong LI, Yantai (CN); Guoqiang GENG, Yantai (CN); Mingjie ZHANG, Yantai (CN)

(21) Appl. No.: 15/690,238

(22) Filed: Aug. 29, 2017

(30) Foreign Application Priority Data
Aug. 31, 2016 (CN) 201610776183.5

(51) Int. Cl. H01F 1/057; H01F 1/053; C22C 1/04; B22F 1/00

(52) U.S. Cl. CPC H01F 1/0577; B22F 1/0003; C22C 1/04; H01F 1/0536

(57) ABSTRACT

A method for producing a sintered R-iron (Fe)-boron (B) magnet, the method including: (1) producing a sintered magnet R1-Fe—B-M; (2) washing the sintered magnet using an acid solution and deionized water, successively, and drying the sintered magnet to yield a treated magnet; (3) mixing a heavy rare earth element powder RX, an organic solid powder EP and an organic solvent ET to yield a slurry RXE, coating the slurry RXE on the surface of the treated magnet, and drying the treated magnet to yield a treatment unit; and (4) heating, quenching, and then aging the treatment unit.

### CROSS-REFERENCE TO RELATED APPLICATIONS

Pursuant to 35 U.S.C. §119 and the Paris Convention Treaty, this application claims foreign priority to Chinese Patent Application No. 201610776183.5 filed Aug. 31, 2016, the contents of which are incorporated herein by reference.

### BACKGROUND OF THE INVENTION

### Field of the Invention

The invention relates to a method for producing a sintered R-Iron-Boron (R—Fe—B) magnet.

### Description of the Related Art

Grain boundary diffusion methods, including evaporation process and contact process, are widely used to improve the coercive force of sintered Nd—Fe—B magnets.

The temperature of the evaporation process is difficult to control. If the temperature is too low, it is difficult for the heavy rare earth vapor to diffuse into the interior of magnets, leading to long treatment time. If the temperature is too high, the speed of producing heavy rare earth vapor is faster than the speed of vapor diffusing into the interior of magnets, leading to a poor grain boundary diffusion effect.

For the contract process, a heavy rare earth film is coated on the surface of magnets, destroying the surface condition of the magnets. In addition, to ensure satisfactory magnetic properties, the surface coating requires to be removed, which involves complex operations and increases the costs.

### SUMMARY OF THE INVENTION

In view of the above-described problems, it is one objective of the invention to provide a method for producing a sintered R-Iron-Boron (R—Fe—B) magnet.

To achieve the above objective, in accordance with one embodiment of the invention, there is provided a method for producing a sintered R—Fe—B magnet, the method comprising:
(1) producing a sintered magnet R1-Fe—B-M, wherein R1 is neodymium (Nd), praseodymium (Pr), terbium (Tb), dysprosium (Dy), gadolinium (Gd), holmium (Ho), or a combination thereof, and accounts for 27-34 wt. % of a total weight of the sintered magnet R1-Fe—B-M, the boron (B) accounts for 0.8-1.3 wt. % of the total weight of the sintered magnet R1-Fe—B-M; M is titanium (Ti), vanadium (V), chromium (Cr), manganese (Mn), cobalt (Co), gallium (Ga), copper (Cu), silicon (Si), aluminum (Al), zirconium (Zr), niobium (Nb), tungsten (W), molybdenum (Mo), or a combination thereof, and accounts for 0-5 wt. % of the total weight of the sintered magnet R1-Fe—B-M; the rest is Fe;
(2) washing the sintered magnet using an acid solution and deionized water, successively, and drying the sintered magnet to yield a treated magnet;
(3) mixing a heavy rare earth element powder RX, an organic solid powder EP and an organic solvent ET to yield a slurry RXE, coating the slurry RXE on a surface of the treated magnet, and drying the treated magnet to yield a treatment unit comprising a REX layer, wherein the heavy rare earth element powder RX is Dy powder, Tb powder, hydrogenated Dy powder, hydrogenated Tb powder, dysprosium fluoride powder, terbium fluoride powder, or a combination thereof, the organic solid powder EP is rosin-modified alkyd resin, thermoplastic phenolic resin, urea-formaldehyde resin, polyvinyl butyral, or a combination thereof, and the organic solvent ET is ethyl alcohol, ether, benzene, glycerol, ethanediol, or a combination thereof; and
(4) heating the treatment unit in (3) at a temperature of between 850° C. and 970° C. for between 0.5 and 48 hrs, quenching the treatment unit, and then aging the treatment unit at a temperature of between 430° C. and 650° C. for between 2 and 10 hrs.

The heavy rare earth element powder RX, the organic solid EP and the organic solvent ET are used to prepare the slurry RXE; the evenly-stirred slurry RXE is coated on the surface of the treated magnet; after a drying treatment, an RXE layer is formed on the surface of the magnet to realize the effect of arranging heavy rare earth elements on the surface of the magnet. The RXE layer can be arranged on the surface of the magnet through brush coating, dipping, roller coating and spray painting. The RXE layer is highly controllable in thickness and uniformity, is not easy to fall off and is easy to realize batch production. Since the heavy rare earth element RX is wrapped by the organic solid powder EP after drying treatment, the RXE layer on the surface of the magnet is not easy to oxidize. Therefore, the magnet can keep stable in the air for a long time. During heat treatment, the organic solid powder EP and the organic solvent ET are separated from the magnet so the content of carbon in the magnet will not increase significantly.

In a class of this embodiment, in step (3), the slurry RXE needs to be stirred in use. Since the density of the powder RX is much greater than that of EP and ET, the slurry RXE still cannot keep stable and uniform for a long time although the organic solid EP used in the thick liquid prevents the powder RX from settling obviously. Therefore, the slurry RXE is stirred preferably in use.

In a class of this embodiment, in (3), the weight percent of the RX in the slurry RXE ranges from 30 wt. % to 90 wt. %. When the weight percent of the RX in the slurry RXE is too low, since the density of the powder RX is higher, the distribution uniformity of the RX in the slurry RXE lowers even if stir treatment is carried out so that the RX on the surface of the treated magnet is not even in distribution. When the weight percent of the RX in the slurry RXE is too high, the flowability of the thick liquid becomes lower and the viscosity of the thick liquid becomes higher so it is not easy to arrange an RXE layer which is even in thickness on the surface of the treated magnet.

In a class of this embodiment, in step (3), the slurry RXE is arranged on the surface of a regular square magnet through brush coating and roller coating. The slurry RXE is arranged on the surface of an irregular magnet through dipping and spray coating.

As for a regular square magnet, the slurry RXE forms an RXE layer which is even in thickness on the surface of the magnet through brush coating, roller coating, dipping and spray coating. The powder RX is distributed on the surface of the magnet evenly. As for an irregular magnet, it is easier to adopt dipping and spray coating to realize the even distribution of the RXE layer.

In a class of this embodiment, in step (3), the grain size of the heave rare earth powder RX is less than 30 μm and the thickness of the RXE layer ranges from 10 μm to 200 μm. When the grain size of RX particles is greater than 30 μm, it is easy for RX to settle and not easy to form the slurry RXE with high uniformity. Therefore, it is harder to form an RXE layer on the surface of the magnet. When the coating is thinner it is easy to form granular bulges on the coating surface and then the diffusion uniformity of the magnet will finally be affected. The thickness of the RXE layer is controlled within a certain range because when the RXE layer is too thin the grain size of the RX particles in the RXE layer is close to the thickness of the coating and it is harder to realize even distribution of the RX particles. Therefore, the heavy rare earth elements which diffuse into the interior of the magnet from the surface of the magnet are not even in distribution, and finally the uniformity of the magnet is poor. When the RXE layer is too thick, the RXE layer has excessive RX. The excessive RX cannot entirely diffuse into the interior of the magnet during heat treatment, gathers on the surface of the magnet, corrodes the surface of the magnet, and affects the surface condition of the magnet. When the RXE layer is too thick, the RXE layer has excessive EP and ET. Therefore, a lot of organic materials come out during heat treatment. If the excessive EP and ET cannot be discharged in time, the air of heat treatment equipment will be affected, the content of carbon and oxygen in the magnet will increase and the magnet performance will be finally affected.

In step (3), the organic solvent ET is one or more of ethanol, benzene, glycerol and ethanediol and the ethanol is the preferred one. Compared to ethanol, benzene, glycerol and ethanediol are more harmful to human bodies. During solidification and heat treatment, a lot of ET will fall off at a high temperature. If benzene, glycerol and ethanediol are used as an organic solvent ET, they have higher requirements on the air tightness, air-discharging capacity and safety of equipment. Therefore, the cost of equipment increases.

In a class of this embodiment, in step (3), the treated magnet at least has one direction with thickness less than 10 mm.

During heat treatment, the heavy rare earth element RX diffuses into the interior of the magnet through liquid-like grain boundaries. The diffusion is mainly driven by concentration differences. If the concentration difference is lower, the driving force is not strong and then the diffusion is slow. When the magnet thickness is greater than 10 mm, it is very hard to realize full diffusion, and then the magnetic properties like Hk/Hcj become poor, and finally the temperature resistance of the magnet is affected.

The invention uses the heavy rare earth element powder RX, organic solid EP and organic solvent ET to prepare slurry RXE which is arranged on the surface of the magnet. After drying treatment, an RXE layer is formed on the surface of the magnet to realize the arrangement of heavy rare earth elements on the surface of the magnet, and then the magnet can be stored stably in the air for a long time. During heat treatment, the organic solid powder EP and the organic solvent ET are separated from the magnet so the content of carbon in the magnet will not increase obviously. The heavy rare earth elements in the heavy rare earth element powder RX diffuse into the interior of the magnet and realize grain boundary diffusion to improve magnet properties. During batch production, the slurry RXE can be arranged on the surface of the magnet through brush coating, dipping, roller coating and spray coating. The thickness of the RXE layer is controllable. It is easy to realize automatic production.

### DETAILED DESCRIPTION OF THE EMBODIMENTS

For further illustrating the invention, experiments detailing a method for producing a sintered R—Fe—B magnet are described hereinbelow combined with the drawings. It should be noted that the following examples are intended to describe and not to limit the invention.

### Example 1

Raw materials were melted in a vacuum melting furnace under the protection of inert gas to form R—Fe—B alloy scales with the thickness ranging from 0.1 mm to 0.5 mm. The metallographic grain boundaries of the scales were clear. After mechanical comminution and hydro-treatment, the alloy scales were ground by nitrogen gas flow until the surface mean diameter (SMD) was 3.2 μm. The 15 KOe magnetic field orientation was adopted for compression molding to produce pressings. The density of the pressings was 3.95 g/cm³. The pressings were sintered in a vacuum in a sintering furnace. The pressings were sintered at the highest temperature of 1080° C. for 330 minutes to produce green pressings. After wire-electrode cutting, the green pressings become magnetic sheets. The size of the magnetic sheets was 40 mm*30 mm*2.1 mm and the size tolerance was ±0.03 mm. The surface of the magnetic sheets was washed by acid solutions and deionized water. After drying treatment, a treated magnet M1 was produced. The composition of the treated magnet M1 is shown in Table 2 below.

Heavy rare earth element powder TbH, organic solid rosin-modified alkyd resin powder and ethanol were mixed to prepare a slurry RXE. The weight percents of the TbH, the rosin-modified alkyd resin powder and the ethanol were 60 wt. %, 5 wt. % and 35 wt. %, respectively. Stir the slurry RXE for about 60 minutes. Dip the treated magnet M1 in the slurry RXE for about 3 seconds and then take the treated magnet M1 out. Put the treated magnet M1 in a drying oven at a temperature of 70° C. for about 15 minutes to produce the treated magnet with an RXE layer on the surface.

Put the treated magnet with an RXE layer in a material box for heat treatment in heat treatment equipment. After the temperature rose to 920° C., keep the magnet at the temperature of 920° C. for 18 hours and then chill the magnet quickly. Then, the temperature rose to 500° C. for aging treatment (the aging treatment refers to the heat treatment process that the properties, shapes and sizes of alloy work pieces after solution treatment, cold plastic deformation or casting and forging change with time at a higher temperature or the room temperature). Keep the magnet at a temperature of 500° C. for 4 hours and then chill the magnet quickly to the room temperature to produce the magnet M2.

TABLE 1
Comparison of properties of magnet M2 and treated
magnet M1 before diffusion treatment

| | Density | Br | Hcj | (BH) max | Hk/Hcj |
|---|---|---|---|---|---|
| | Unit | | | | |
| Items | (g/cm³) | kGs | kOe | MGOe | — |
| M2 | 7.56 | 13.87 | 22.79 | 46.35 | 0.95 |
| M1 | 7.56 | 14.06 | 13.46 | 47.09 | 0.97 |

TABLE 2
Comparison of main compositions of magnet M2 and treated magnet M1
before diffusion treatment

| Items | B | Al | Co | Dy | Tb | Pr | Nd |
|---|---|---|---|---|---|---|---|
| M2 measured value % | 0.97 | 0.1 | 0.89 | 0.51 | 0.48 | 4.71 | 25.65 |
| M1 measured value % | 0.97 | 0.1 | 0.9 | 0.52 | 0 | 4.72 | 25.67 |

As shown in Tables 1 and 2, compared to the treated magnet M1, the residual magnetism Br of the magnet M2 is reduced by about 190 Gs, and the Hcj of the magnet M2 increases by about 9.33 KOe through this method. According to the composition tests, compared to the treated magnet M1, Tb of the magnet M2 increases by about 0.48 wt. %.

TABLE 3
Comparison of CSON element content between magnet
M2 and treated magnet M1 before diffusion treatment

| Items | C | S % | O % | N % |
|---|---|---|---|---|
| M2 measured value % | 0.0742 | 0.0011 | 0.0999 | 0.0304 |
| M1 measured value % | 0.0721 | 0.0009 | 0.0980 | 0.0321 |

Table 3 shows the comparison of the CSON element content of the magnet before and after diffusion treatment. The content of C and the content of O both do not have an obvious increase. It means that most organic rosin-modified alkyd resin does not diffuse into the interior of the magnet during the diffusion process.

### Example 2

Raw materials were melted in a vacuum melting furnace under the protection of inert gas to form R—Fe—B alloy scales with the thickness ranging from 0.1 mm to 0.5 mm. The metallographic grain boundaries of the scales were clear. After mechanical comminution and hydro-treatment, the alloy scales were ground by nitrogen gas flow until the surface mean diameter (SMD) was 3.1 μm. The 15 KOe magnetic field orientation was adopted for compression molding to produce pressings. The density of the pressings was 3.95 g/cm³. The pressings were sintered in a vacuum in a sintering furnace. The pressings were sintered at the highest temperature of 1085° C. for 330 minutes to produce green pressings. After wire-electrode cutting, the green pressings become magnetic sheets. The size of the magnetic sheets was 40 mm*30 mm*3 mm and the size tolerance was ±0.03 mm. The surface of the magnetic sheets was washed by acid solutions and deionized water. After drying treatment, a treated magnet M3 was produced. The composition of the treated magnet M3 is shown in Table 5 below.

Heavy rare earth element powder TbF, polyvinyl butyral and ethanol were mixed to prepare a slurry RXE. The weight percents of the TbF, the polyvinyl butyral and the ethanol were 65 wt. %, 6 wt. % and 29 wt. %, respectively. Stir the slurry RXE for about 60 minutes. Dip the treated magnet M3 in the slurry RXE for about 3 seconds and then take the treated magnet M3 out. Put the treated magnet M3 in a drying oven at a temperature of 70° C. for about 15 minutes to produce the treated magnet with an RXE layer on the surface.

Put the treated magnet with an RXE layer in a material box for heat treatment in heat treatment equipment. After the temperature rose to 920° C., keep the magnet at the temperature of 930° C. for 20 hours and then chill the magnet quickly. Then, the temperature rose to 520° C. for aging treatment. Keep the magnet at a temperature of 520° C. for 4 hours and then chill the magnet quickly to the room temperature to produce the magnet M4.

TABLE 4
Comparison of properties of magnet M4 and treated
magnet M3 before diffusion treatment

| | Density | Br | Hcj | (BH) max | Hk/Hcj |
|---|---|---|---|---|---|
| | Unit | | | | |
| Items | (g/cm³) | kGs | kOe | MGOe | — |
| M2 | 7.56 | 14.19 | 24.32 | 48.25 | 0.95 |
| M1 | 7.56 | 14.36 | 14.46 | 49.09 | 0.97 |

TABLE 5
Comparison of main compositions of magnet M4 and treated magnet M3
before diffusion treatment

| Items | B | Al | Co | Tb | Pr | Nd |
|---|---|---|---|---|---|---|
| M2 measured value % | 0.97 | 0.15 | 0.8 | 0.92 | 4.72 | 25.63 |
| M1 measured value % | 0.97 | 0.15 | 0.8 | 0.5 | 4.72 | 25.67 |

As shown in Tables 4 and 5, compared to the treated magnet M3, the residual magnetism Br of the magnet M4 is reduced by about 170 Gs, and the Hcj of the magnet M4 increases by about 9.86 KOe through this method. According to the composition tests, compared to the treated magnet M3, Tb of the magnet M4 increases by about 0.48 wt. %.

TABLE 6
Comparison of CSON element content between magnet
M4 and treated magnet M3 before diffusion treatment

| Items | C | S % | O % | N % |
|---|---|---|---|---|
| M2 measured value % | 0.0721 | 0.0014 | 0.0673 | 0.0312 |
| M1 measured value % | 0.0678 | 0.0012 | 0.0636 | 0.0298 |

Table 6 shows the comparison of the CSON element content of the magnet before and after diffusion treatment. The content of C and the content of O both do not have an obvious increase. It means that most polyvinyl butyral does not diffuse into the interior of the magnet during the diffusion process.

### Example 3

Raw materials were melted in a vacuum melting furnace under the protection of inert gas to form R—Fe—B alloy scales with the thickness ranging from 0.1 mm to 0.5 mm. The metallographic grain boundaries of the scales were clear. The alloy scales were ground by jet milling to yield powders having the surface mean diameter (SMD) of 3.2 μm. The 15 KOe magnetic field orientation was adopted for compression molding to produce pressings. The density of the pressings was 3.95 g/cm³. The pressings were sintered in a vacuum in a sintering furnace. The pressings were sintered at the highest temperature of 1085° C. for 300 minutes to produce green pressings. After wire-electrode cutting, the green pressings become magnetic sheets. The size of the magnetic sheets was 40 mm*25 mm*4.5 mm and the size tolerance was ±0.03 mm. The surface of the magnetic sheets was washed by acid solutions and deionized water. After drying treatment, a treated magnet M5 was produced. The composition of the treated magnet M5 is shown in Table 8 below.

Heavy rare earth element powders TbF and Tb, organic solid urea resin and ethanol were mixed to prepare a slurry RXE, and the weight percents thereof were 60 wt. %, 6 wt. % and 34 wt. %, respectively. The maximum particle size of the mixed powders of TbF and Tb was less than 18 μm. Stir the slurry RXE for about 60 minutes. The treated magnet M5 was coated with a layer of RXE slurry. Put the treated magnet M5 in a drying oven at a temperature of 90° C. for about 15 minutes to produce the treated magnet with an RXE layer on the surface. The weight of the treated magnet M5 was increased by 1.02 wt. %.

Put the treated magnet with an RXE layer in a material box for heat treatment in heat treatment equipment. After the temperature rose to 930° C., keep the magnet at the temperature of 930° C. for 25 hours and then chill the magnet quickly. Then, the temperature rose to 540° C. for aging treatment. Keep the magnet at a temperature of 540° C. for 4 hours and then chill the magnet quickly to the room temperature to produce the magnet M6.

TABLE 7
Comparison of properties of magnet M6 and treated
magnet M5 before diffusion treatment

| | Density | Br | Hcj | (BH)max | Hk/Hcj |
|---|---|---|---|---|---|
| | Unit | | | | |
| Items | (g/cm³) | kGs | kOe | MGOe | — |
| M2 | 7.58 | 14.16 | 25.22 | 47.87 | 0.94 |
| M1 | 7.57 | 14.31 | 15.42 | 48.73 | 0.98 |

TABLE 8
Comparison of main compositions of magnet M6 and treated magnet M5
before diffusion treatment

| Items | B | Al | Co | Dy | Tb | Pr | Nd |
|---|---|---|---|---|---|---|---|
| M2 measured value % | 0.98 | 0.1 | 0.6 | 0.68 | 0.91 | 5.87 | 22.37 |
| M1 measured value % | 0.99 | 0.1 | 0.6 | 0.70 | 0.5 | 5.88 | 22.40 |

As shown in Tables 7 and 8, compared to the treated magnet M5, the residual magnetism Br of the magnet M6 is reduced by about 150 Gs, and the Hcj of the magnet M6 increases by about 9.8 KOe through this method. According to the composition tests, compared to the treated magnet M5, Tb of the magnet M6 increases by about 0.41 wt. %. Since the magnet is relatively thick, the holding time for thermal treatment at 930° C. is significantly longer than that in examples 1 and 2.

TABLE 9
Comparison of CSON element content between magnet
M6 and treated magnet M5 before diffusion treatment

| Items | C | S % | O % | N % |
|---|---|---|---|---|
| M2 measured value % | 0.0742 | 0.0011 | 0.0999 | 0.0304 |
| M1 measured value % | 0.0721 | 0.0009 | 0.0980 | 0.0321 |

Table 9 shows the comparison of the CSON element content of the magnet before and after diffusion treatment. The content of C and the content of 0 both do not have an obvious increase. It means that most urea resin does not diffuse into the interior of the magnet during the diffusion process.

Unless otherwise indicated, the numerical ranges involved in the invention include the end values. While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A method for producing a sintered R-Iron-Boron (R—Fe—B) magnet, the method comprising:
(1) producing a sintered magnet R1-Fe—B-M, wherein R1 is neodymium (Nd), praseodymium (Pr), terbium (Tb), dysprosium (Dy), gadolinium (Gd), holmium (Ho), or a combination thereof, and accounts for 27-34 wt. % of the total weight of the sintered magnet R1-Fe—B-M; the boron (B) accounts for 0.8-1.3 wt. % of the total weight of the sintered magnet R1-Fe—B-M; M is titanium (Ti), vanadium (V), chromium (Cr), manganese (Mn), cobalt (Co), gallium (Ga), copper (Cu), silicon (Si), aluminum (Al), zirconium (Zr), niobium (Nb), tungsten (W), molybdenum (Mo), or a combination thereof, and accounts for 0-5 wt. % of the total weight of the sintered magnet R1-Fe—B-M; and the rest is Fe;
(2) washing the sintered magnet using an acid solution and deionized water, successively, and drying the sintered magnet to yield a treated magnet;
(3) mixing a heavy rare earth element powder RX, an organic solid powder EP and an organic solvent ET to yield a slurry RXE, coating the slurry RXE on a surface of the treated magnet, and drying the treated magnet to yield a treatment unit comprising a REX layer, wherein the heavy rare earth element powder RX is Dy powder, Tb powder, hydrogenated Dy powder, hydrogenated Tb powder, dysprosium fluoride powder, terbium fluoride powder, or a combination thereof, the organic solid powder EP is rosin-modified alkyd resin, thermoplastic phenolic resin, urea-formaldehyde resin, polyvinyl butyral, or a combination thereof, and the organic solvent ET is ethyl alcohol, ether, benzene, glycerol, ethanediol, or a combination thereof; and
(4) heating the treatment unit in (3) at a temperature of between 850° C. and 970° C. for between 0.5 and 48 hrs, quenching the treatment unit, and then aging the treatment unit at a temperature of between 430° C. and 650° C. for between 2 and 10 hrs.

2. The method of claim 1, wherein a particle size of the heavy rare earth element powder RX is less than 100 μm.

3. The method of claim 1, wherein in (3), the REX layer is between 3 and 500 μm in thickness.

4. The method of claim 1, wherein in (3), a weight percent of the powder RX in the slurry RXE ranges from 30 wt. % to 90 wt. %.

5. The method of claim 1, wherein in (3), a thickness of the treated magnet in at least one direction is less than 10 mm.

6. The method of claim 2, wherein the particle size of the heavy rare earth element powder RX is less than 30 μm

7. The method of claim 3, wherein the REX layer is between 10 and 200 μm in thickness.
